(19) United States
(12) Patent Application Publication
(10) Pub. No.: US 2003/0202004 A1
(43) Pub. Date: Oct. 30, 2003

(54) System and method for providing a low-bit rate distributed slide show presentation

(76) Inventor: I-Jong Lin, Woodside, CA (US)

Correspondence Address: HEWLETT-PACKARD COMPANY, Intellectual Property Administration, P.O. Box 272400, Fort Collins, CO, 80527-2400, US

(21) Appl. No.: 10/137,518

(22) Filed: Apr. 30, 2002

(51) Int. Cl. G09G 5/00

(52) U.S. Cl. 345/716; 345/732; 345/704

(57) ABSTRACT

A technique of implementing a distributed real-time slide presentation environment for facilitating low bit rate bi-directional classroom participation is described. Initially, a real-time slide presentation is presented using a computer controlled display and is captured. The captured data is used to generate synchronized overlayed replayable bitstreams including at least a bitstream corresponding to symbolic representations of a presenter's interaction with each slide captured during the presentation. The bitstream is transmitted to at least one viewing location having the capability to play the bitstream during the real-time presentation. A low bit rate digital signal having a corresponding displayable visual representation can be transmitted from the viewing location to the presentation location. The digital signal which can be combined with the first bitstream can also be transmitted such that the visual representation of the digital signal is displayed in the real-time slide presentation at the presentation location.

### FIELD OF THE INVENTION

The present invention relates to a system and method for providing a distributed slide show presentation, and in particular, this disclosure provides a system and method for facilitating dynamic bi-directional communication in a distributed slide show presentation.

### BACKGROUND OF THE INVENTION

A typical distributed classroom presentation environment includes a presenter/teacher giving a presentation/lecture to an audience (with or without computers) using a slide presentation at a first location and electronically transmitting the presentation to a group of individuals/students at a second remote location. The main advantage of this type of classroom is that it gives the individuals/students the flexibility of not attending the physical location of the real-time presentation.

Often, a presentation that is to be distributed to other locations is video taped and the audio and video signals of the presentation are transmitted in real-time to an audio/video device at each remote location allowing real-time viewing of the presentation at the remote locations. The main disadvantage of implementing a distributed classroom in this manner is that the remote location must have the bandwidth capability required to receive the audio/video signal. A remote location not having the bandwidth capability cannot participate in the distributed classroom. This can often limit the participants at remote locations in that they can only participate at designated (i.e., large bandwidth) locations thereby minimizing the flexibility of the distributed classroom environment. For instance, it would be desirable to view and participate in a distributed classroom environment using a laptop computer or PDA. However, these devices typically do not have adequate bandwidth capability to handle a video taped presentation in real-time.

In addition, it is also desirable in a distributed classroom environment to provide the remote location participant the ability to interact with the presenter and the real-time presentation in such a way where all participants at all locations can simultaneously view and/or hear the interaction on a real-time basis. However, this too often entails video signal transmission thereby again presenting bandwidth limitation issues. In addition, although this interaction may be incorporated within a video tape, it is not included within the slide presentation and as a result, an individual viewing the slides after the presentation will not have the benefit of the participants interactions. In addition, it would be desirable if the remote/local participants share a common experience when viewing the presentation. In particular, it would be desirable such that the local participants have the benefit of the remote participant interactions and the remote participants have the benefit of the local participant interactions.

What is needed is a distributed classroom environment having low bandwidth requirements and allowing real-time participation of both remote and local users.

### SUMMARY OF THE INVENTION

A system and method of distributing a real-time slide presentation system is described for facilitating a low-bit rate bi-directional distributed classroom environment. In a first embodiment a real-time slide presentation is presented using a computer controlled display and is captured. The captured presentation data is used to generate synchronized overlayed replayable bitstreams including at least a first bitstream corresponding to an image of each of a plurality of slides of the slide presentation, a second bitstream corresponding to symbolic representations of a presenter's interaction with each slide captured during the presentation, and a third bitstream corresponding to an audio signal of the presentation captured during the presentation. The bitstream is transmitted to at least one viewing location having the capability to play the bitstream during the real-time presentation. A digital signal having a corresponding displayable visual representation can be transmitted from the viewing location to the presentation location. The digital signal which can be combined with the first bitstream can also be transmitted such that the visual representation of the digital signal is displayed in the real-time slide presentation at the presentation location.

### BRIEF DESCRIPTION OF THE DRAWINGS

FIG. 1 illustrates an example of a system for capturing a real-time slide presentation and for generating a multimedia data object representing the presentation;

FIG. 2 shows a multimedia data object including a plurality of bitstreams;

FIG. 3A illustrates a presenter's interaction with a point of interest within the display area of a displayed slide presentation;

FIG. 3B illustrates the insertion of a symbolic representation of the presenter's interaction within the displayed slide presentation shown in FIG. 3A;

FIG. 3C shows a replayed slide of a multimedia data object including a symbolic representation of a previously recorded presenter's interaction shown in FIG. 3B;

FIG. 4 illustrates one embodiment of a multimedia data object unit according to the present invention;

FIG. 5 illustrates an embodiment of a distributed real-time slide presentation system in accordance with the present invention; and

FIG. 6 illustrates an embodiment of a method of distributing a low bitrate real-time slide presentation in accordance with the present invention.

### DETAILED DESCRIPTION OF THE INVENTION

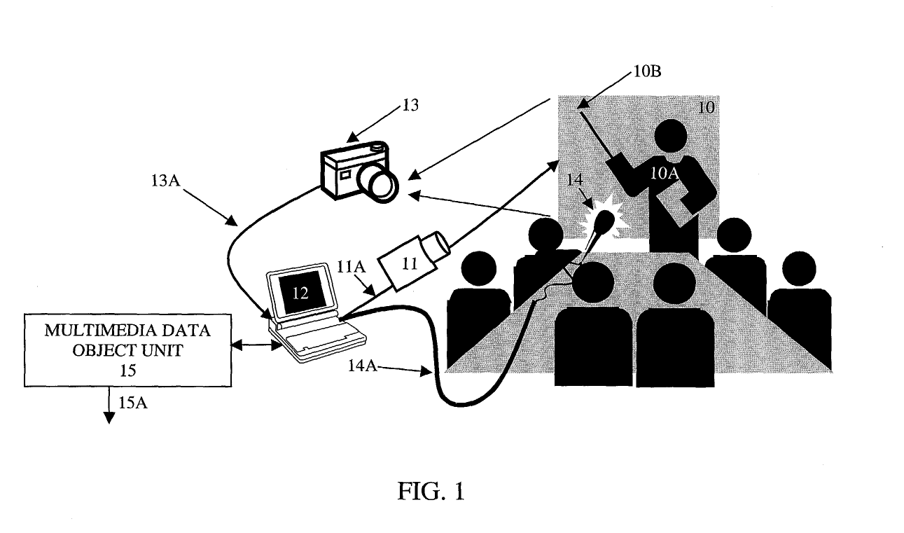

FIG. 1 shows an example of a system for capturing a real-time computer controlled slide presentation and for generating a multimedia data object representing the presentation. A display area 10 displays a plurality of slides (not shown) while a presenter 10A is positioned in front of the display area so as to present the slides. In this example, a projector 11 displays the slides. The projector is driven by an image signal 11A that represents the slides and which is provided by a laptop computer 12. It should be understood that other arrangements for displaying a computer controllable slide presentation are well known in the field. As each slide is shown in a generally sequential manner, the presenter 10A adds verbal annotations describing its contents while pointing at points of interest within it. For instance, the presenter may point to a bullet point within the slide and then add a verbal description of the text adjacent to the bullet point. The action or event of the presenter pointing at a point of interest within the slide is herein referred to as a presenter interaction.

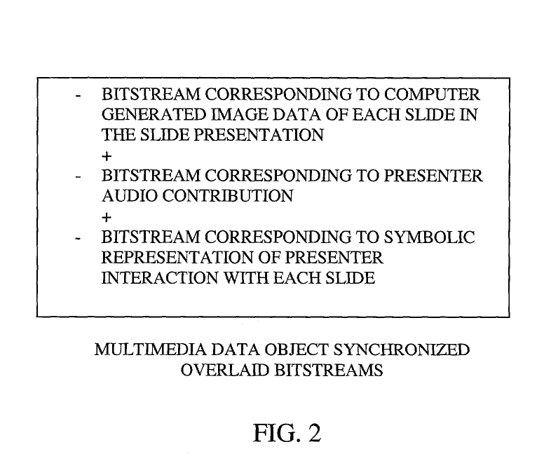

The multimedia data object unit 15 functions to generate a multimedia data object including a plurality of synchronized overlaid replayable bitstreams 15A representing the real-time slide presentation captured by image capture device 13 and audio signal capture device 14. In one embodiment shown in FIG. 2, the replayable bitstreams 15A include a first bitstream corresponding to computer generated image data 11A representing each slide in the presentation provided by the computing system 12, a second bitstream corresponding to a plurality of symbolic representations of the presenter's interactions with each slide, and a third bitstream corresponding to the presenter's audio signal 14A provided by the audio signal capture device 14.

According to the present invention a multimedia data object (e.g., FIG. 2) is recorded by initially 1) capturing during the real-time slide presentation an image of the display area 10 (FIG. 1) displaying the slides and the presenter's interactions with each slide within the display area 10 with an image capture device 13, and 2) capturing the presenter's speech using an audio signal capture device 14. The image capture device 13 and the audio signal recording device 14 provide a captured image signal 13A and the captured audio signal 14A, respectively, to the computing system 12, and more specifically to the multimedia data object unit 15.

During the real-time slide presentation, the multimedia data object unit 15 may function to cause a symbol to be displayed at the point of interest within the slide that the presenter interacts with during the real-time slide presentation. Specifically, as will be herein described below, multimedia data object unit 15 is 1) able to identify, within captured image data, the location of the display area within the image capture device capture area, 2) able to identify and locate within the captured image data objects in front of the display area including a presenter and/or an elongated pointing instrument, and 3) able to locate a point of interest of the objects in front of the display area such as the tip of the elongated pointing instrument or a point of interest corresponding to an illumination point generated by a laser pointer. As a result, the unit 15 can locate the point of interest within the image signal 11A of the corresponding slide being displayed and insert a digital symbol representing the presenter interaction with the point of interest during the real-time slide presentation.

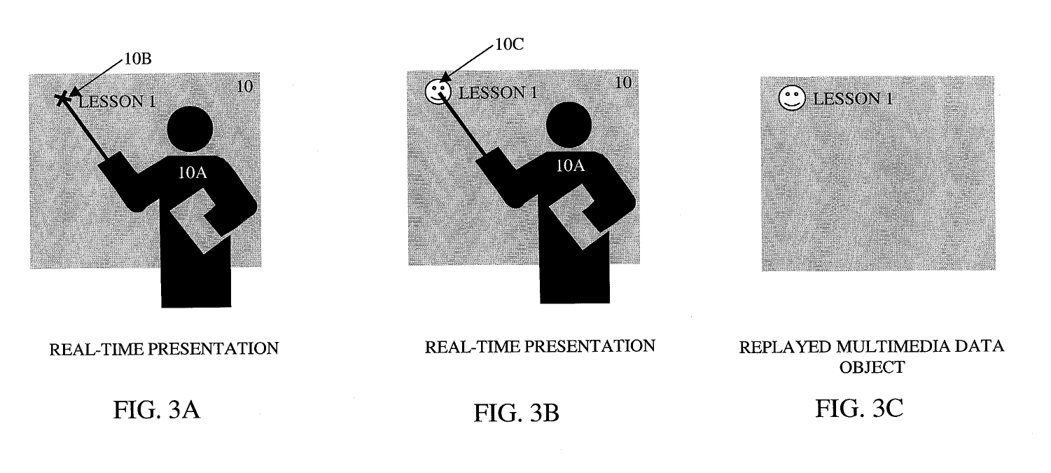

For instance, referring to FIG. 3A, the presenter 10A can physically point at a point of interest 10B within the display area 10 residing between the line of sight of the image capture device and the displayed slides. Upon physically pointing, a selected symbol (10C) is displayed within the slide at that point as shown in FIG. 3B. This predetermined symbol is referred to herein as a symbolic representation of the presenter interaction.

When the plurality of bitstreams 15A are replayed by using a computer controllable display screen and an audio playback device (i.e., audio speaker), the display area displays the image of each slide according to the first bitstream having synchronously overlaid upon it the symbolic representations of the presenter's interactions corresponding to the second bitstream while the audio device synchronously replays the third audio bitstream. For example, FIG. 3C shows a replayed slide corresponding to the captured image of the real-time slide presentation shown in FIG. 3B. As shown in FIG. 3C, the image of the slide includes the image of the slide (i.e., “LESSON 1”) and the overlaid image of the symbolic representation of the presenter's interaction 10C (i.e., the smiley face). Note, that although a video image of the presenter is not shown, the presenter's interaction with the slides is still represented within the replayed slide in a low bitrate format.

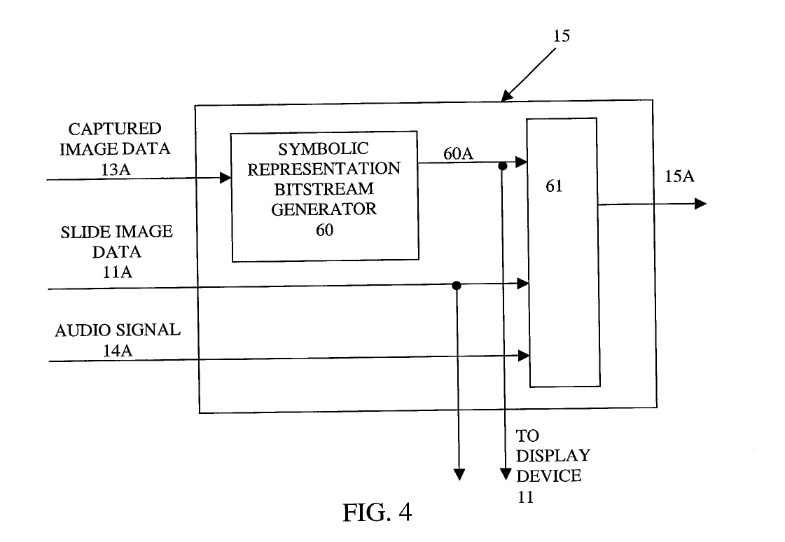

FIG. 4 shows an embodiment of the multimedia data object unit 15 of the present invention for generating a plurality of bitstreams 15A representing a recording of a real-time slide presentation. Coupled to the unit 15 are at least three input signals corresponding to the real-time presentation including captured image data 13A, slide image data 11A, and audio signal 14A. The slide image data 11A represents computer generated image data for driving a display device so as to display a plurality of slides during the presentation. Captured image data 13A corresponds to images captured during the real-time presentation including images of the displayed slides and the presenter's interactions with the slides. Audio signal 14A corresponds to the presenter's verbal annotations during the presentation including verbal annotations associated with particular points of interest within the slides.

The captured image data 13A is coupled to a symbolic representation bitstream generator 60 which corresponds to the presenter's interactions with the displayed slides during the real-time presentation. One embodiment of the symbolic representation bitstream generator 60 is described in U.S. application Ser. No.: 09/952,641 (Attorney Docket No.: 100110204-1) entitled “A System For Recording A Presentation” assigned to the assignee of the subject application and incorporated herein by reference. Unit 15 further includes a synchronizer that functions to synchronize the symbolic representation bitstream, the slide image data bitstream, and the audio bitstream on a slide-by-slide basis (with minimal temporal resolution) to generate signal 15A representing the real-time slide presentation. In addition, the symbolic representation bitstream 60A is transmitted along with the slide image data 11A to the display device 11 during the real-time presentation facilitating the display of the symbolic representation at the location of the current point of interest within the slide such as shown in FIG. 3B.

It should be noted that the advantage of the multimedia data object shown in FIG. 2 and the presentation system shown in FIG. 1 is that it represents, in one application, a new content pipeline to the Internet by 1) allowing physically present and remote users to share a common experience of the presentation; 2) allowing easy production of slide presentations as content-rich multimedia data objects; and 3) enabling a new representation of a slide presentation that is extremely low bit rate. The multimedia data object enables distance learning applications over low bandwidth network structures by its compact representation of slide presentations as a document of images and audio crosslinked and synchronized without losing any relevant content of the slide presentation. Furthermore, the multimedia data objects have a naturally compressed form that is also adapted to easy browsing.

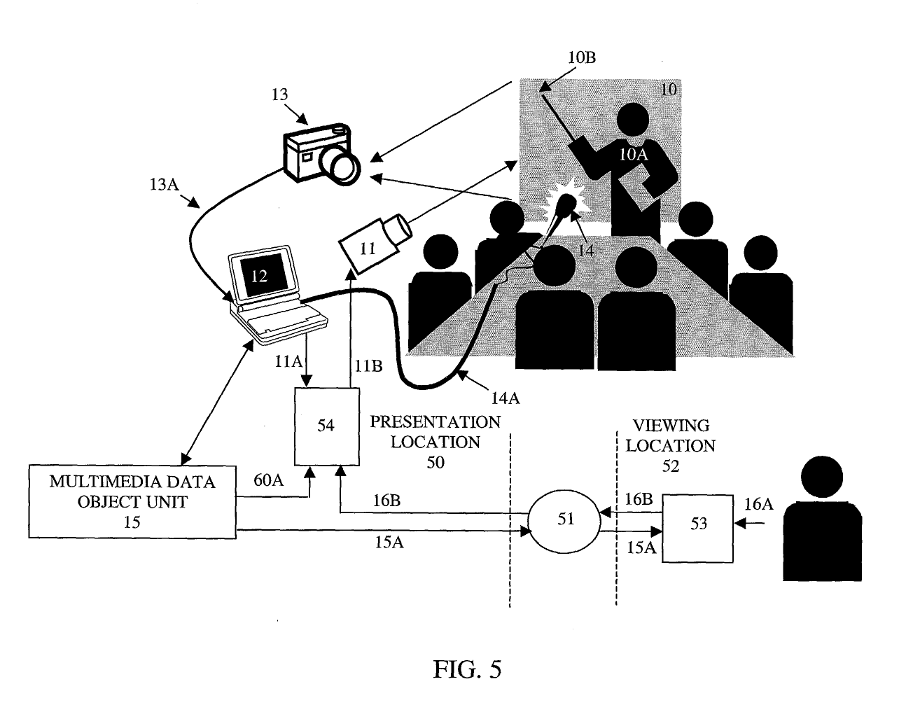

FIG. 5 illustrates an example of a distributed real-time slide presentation environment in accordance with the present invention. The environment includes a display area 10 for displaying a plurality of slides (not shown) while a presenter 10A is positioned in front of the display area so as to present the slides. In this example, a projector 11 displays the slides. The projector is driven by an image signal 11B which includes, in part, the signal 11A that represents the slides provided by a laptop computer 12. It should be understood that other arrangements for displaying a computer controllable slide presentation are well known in the field. As each slide is shown in a generally sequential manner, the presenter 10A adds verbal annotations (i.e., audio signal 14A) describing its contents while pointing at points of interest within it (captured by audio signal recording device 14). The image capture device captures image data 13A where the captured image data 13A corresponds to images captured during the real-time presentation including images of the displayed slides and the presenter's interactions with the slides.

The environment further includes a multimedia object unit 15 for generating a signal 15A representing the real-time slide presentation in response to the slide data 11A, the captured image data 13A, and the audio signal data 14A provided by the laptop computer 12. The signal 15A includes at least synchronized overlayed replayable bitstreams including at least a first bitstream corresponding to an image of each of a plurality of slides of the presentation, a second bitstream corresponding to symbolic representations of a presenter's interaction with each slide captured during the presentation, and a third bitstream corresponding to an audio signal captured during the presentation.

The signal 15A is transmitted from the presentation location 50 on transmission medium 51 to viewing location 52. It should be noted that transmission medium 51 may be a wired or wireless connection and/or may be an internet or intranet connection. In addition, it should be noted that the presentation location 50 and viewing location 52 need not be physically distant and may be in an environment in which students in a classroom having laptop computers at their desk represent viewing locations and the teacher at the front of the classroom may represent the presentation location. Alternatively, the presentation location and viewing locations may be in physically separate locations.

At the viewing location 52, the environment includes unit 53 for receiving, playing, and viewing signal 15A on a real-time basis. In should be noted that unlike typical video taped or video conferenced presentations, signal 15A provides the real-time slide information, audio information, and the real-time symbolic representations of a presenter's interaction in a compact low bitrate format facilitating real-time viewing of the presentation at low bitrate viewing locations. Unit 53 further includes a means for transmitting a user generated displayable digital signal 16B during the real-time presentation. According to the present invention, digital signal 16B has a corresponding displayable visual representation. For instance, digital signal 16B may correspond to an audio signal 16A generated by the viewing location user and the displayable visual representation of the digital signal may be image data corresponding to the textual words that, in turn, correspond to the spoken words in the audio signal. Alternatively, digital signal 16B may correspond to handwritten words generated by the viewing location user and the displayable visual representation may be image data corresponding to textual words that, in turn, correspond to interpreted handwritten words. Alternatively, digital signal 16B can be hand drawn figures. Hence, accordingly, in one embodiment, the present invention unit 53 can include an input device for receiving audio signals, handwritten words, hand drawn figures, documents, etc. and a digital converter for converting audio signals, handwritten words, hand drawn figures, scanned documents, images from a digital camera etc. to a displayable digital signal representation.

The digital signal is transmitted to the presentation location 50 via medium 51 to unit 54 for receiving the digital signal and combining it at least with the slide image data 11A at the presentation location to generate signal 11B for driving the slide display device 11. Hence, in one embodiment, the displayable visual representation corresponding to the digital signal 16B transmitted from the viewing location 52 is displayed during the real-time presentation. In one embodiment, the displayable visual representation is displayed on a separate slide within the slide presentation. For instance, if the digital signal 16B is an audio signal corresponding to a question, the question unit 54 creates a separate slide including the displayable visual representation of the digital signal 16B corresponding to the question on the slide. In one embodiment, the slide is automatically created by a text message sent by a remote user that is automatically formatted and converted into a bitmap corresponding to slide image data either by unit 53 or unit 54. The slide can then be displayed during the real-time presentation. It should be noted that since capture device 13 captures the image of the created slide during the real-time presentation it becomes incorporated into the replayable bitstream signal 15A and is seem at all remote viewing locations during the real-time presentation. In addition, since it is incorporated into the replayable bitstream 15A, the created slide is also viewable when the bitstream 15A is replayed. As a result, the participants interactions are captured and become part of the representation of the slide presentation.

In the case in which more than one digital signal 16B is received from more than one viewing location 52, digital signals 16B can be prioritized according to when they are received and then displayed by signal 11B according to their prioritized order—one slide per digital signal. Hence, in one embodiment unit 54 includes a prioritizer. Alternatively, digital signals can be incorporated onto the same slide by differentiating text displayed on the created slide corresponding to each digital signal by inserting a different characters (e.g., icon, symbol, number, letter) before the text.

It should be noted the symbolic representation bitstream 60A is also coupled to unit 54 and is transmitted along with the slide image data 11B to the display device 11 during the real-time presentation facilitating the display of the symbolic representation at the location of the current point of interest within the slide image data portion 11A of slide image data 11B such as shown in FIG. 3B.

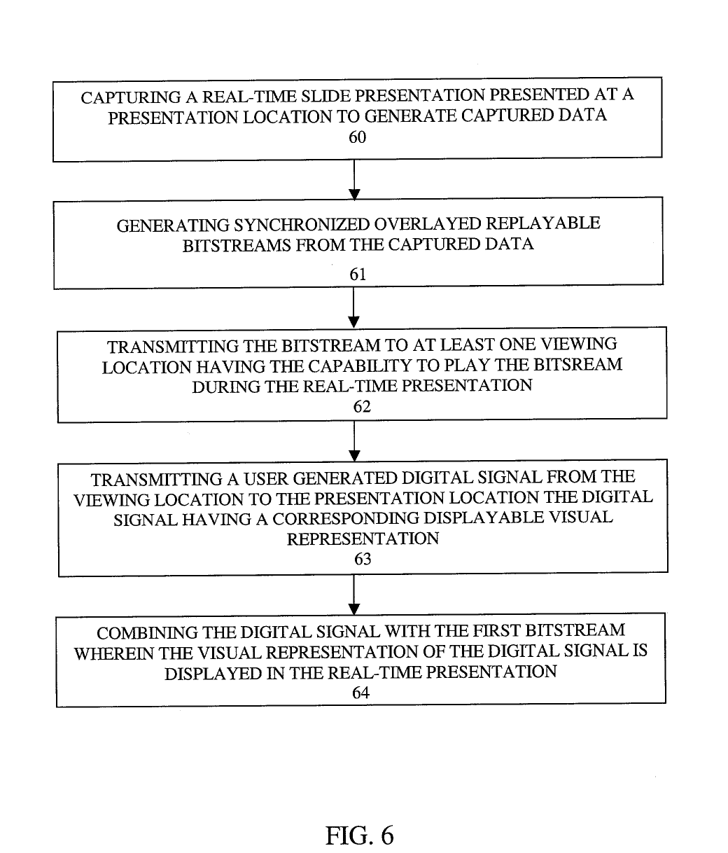

FIG. 6 illustrates one embodiment of a method of distributing a slide show presentation. Initially, a real-time slide presentation presented at a presentation location is captured to generate captured data (60). In one embodiment, the captured data includes audio data 14A captured from the presenter and image data 13A corresponding to the presenter, the display area including the displayed slides, and the presenter's interactions with the slides during the real-time presentation. Synchronized overlayed replayable bitstreams are generated (61) from the captured data (13A and 14A) and the slide image data (11A) and include at least a first bitstream corresponding to an image of each of a plurality of slides of the slide presentation, a second bitstream (60A) corresponding to symbolic representations of a presenter's interaction with each slide captured during the presentation, and a third bitstream corresponding to an audio signal of the presentation captured during the presentation. The replayable bitstreams are transmitted to at least one viewing location having the capability to play the bitstream during the real-time presentation (63). At the viewing location, the user can generate digital signals 16B having corresponding displayable visual representations and the user generated digital signals are transmitted from the viewing location to the presentation location (64). The digital signals are then combined with slide image data 11A wherein the visual representation of the digital signal is displayed in the real-time presentation.

Hence a system and method of implementing a distributed real-time slide presentation system is described for facilitating a low bit rate bi-directional distributed classroom environment and allowing real-time participation to remote users.

In the preceding description, numerous specific details are set forth in order to provide a thorough understanding of the present invention. It will be apparent, however, to one skilled in the art that these specific details need not be employed to practice the present invention. In addition, it is to be understood that the particular embodiments shown and described by way of illustration is in no way intended to be considered limiting. Reference to the details of these embodiments is not intended to limit the scope of the claims.

I claim:

1. A distributed real-time slide presentation system wherein the real-time slide presentation is displayed by a computer controlled display system, the distributed system comprising:
means for capturing the real-time slide presentation at a presentation location and generating synchronized overlayed replayable bitstreams including at least a first bitstream corresponding to an image of each of a plurality of slides of the presentation, a second bitstream corresponding to symbolic representations of a presenter's interaction with each slide captured during the presentation, and a third bitstream corresponding to an audio signal captured during the presentation;
at least one viewing location including a means for receiving, playing, and viewing the bitstream during the presentation and means for transmitting a user generated displayable digital signal during the presentation, the digital signal having a corresponding displayable visual representation;
means for receiving the digital signal and combining it with the first bitstream at the presentation location wherein the visual representation of the displayable digital signal is displayed during the presentation and is incorporated into the replayable bitstream.

2. The system as described in claim 1 wherein the displayable visual representation corresponds to textual image data.

3. The system as described in claim 1 wherein the viewing location comprises a means for inputting user audio signals and means for converting the audio signal into the digital signal.

4. The system as described in claim 1 wherein the viewing location comprises a means for inputting user handwriting and means for converting the handwriting into the digital signal.

5. The system as described in claim 1 wherein the viewing location comprises a means for receiving user hand drawn images and means for converting the images into the digital signal.

6. The system as described in claim 1 wherein the viewing location is one of a hand held computing apparatus, a laptop computer, and a personal computer.

7. The system as described in claim 1 further comprising means for prioritizing digital signals received from more than one viewing location into an order wherein the visual representation of each digital signal is displayed according to the order.

8. A method of distributing a slide show presentation wherein the slide show presentation is displayed by a computer controlled display system, the method comprising:
capturing a real-time slide presentation presented at a presentation location to generate captured data;
generating synchronized overlayed replayable bitstreams from the captured data including at least a first bitstream corresponding to an image of each of a plurality of slides of the slide presentation, a second bitstream corresponding to symbolic representations of a presenter's interaction with each slide captured during the presentation, and a third bitstream corresponding to an audio signal of the presentation captured during the presentation;
transmitting the bitstream to at least one viewing location having the capability to play the bitstream during the real-time presentation;
transmitting a user generated digital signal from the viewing location to the presentation location, the digital signal having a corresponding displayable visual representation;
combining the digital signal with the first bitstream wherein the visual representation of the digital signal is displayed in the real-time presentation thereby incorporating the digital signal into the replayable bitstream.

9. The method as described in claim 8 further comprising converting a user generated hand writing into the digital signal prior to transmitting the digital signal.

10. The method as described in claim 8 further comprising converting a user generated hand drawn images into the digital signal prior to transmitting the digital signal.

11. The method as described in claim 8 further comprising transmitting the digital signal from one of a hand held computing device, a laptop computer, and a personal computer.

12. The method as described in claim 8 further comprising prioritizing a plurality of digital signals prior to combining.

13. The method as described in claim 12 further comprising combining the plurality of digital signals with the first bitstream such that the visual representations of the plurality of digital signals are displayed according an order established when prioritizing.
